(19) United States
(12) Patent Application Publication
(10) Pub. No.: US 2005/0072832 A1
(43) Pub. Date: Apr. 7, 2005

(54) Probe friction sheet welding method

(75) Inventors: Heung-Nam Han, Kyungsangnam-do (KR); Chang-Gil Lee, Kyungsangnam-do (KR); Sung-Joon Kim, Kyungsangnam-do (KR)

Correspondence Address: Richard S. Milner;Cooper & Dunham LLP, 1185 Avenue of the Americas, New York, NY, 10036, US

(73) Assignee: Korea Institute of Machinery and Materials, Daejeon (KR)

(21) Appl. No.: 10/717,334

(22) Filed: Nov. 18, 2003

(30) Foreign Application Priority Data
Oct. 1, 2003 (KR) 2003-68113

(51) Int. Cl. B23K 20/12

(52) U.S. Cl. 228/112.1

(57) ABSTRACT

Disclosed is a friction sheet welding method using a probe for joining two work pieces. The method comprises the steps of producing forcible and intense plastic deformation at surfaces of the work pieces while generating frictional heat at the surfaces by rotating the probe at a high speed, joining the work pieces together as the plastic deformation produced at the surfaces of the work pieces permeates inside material of the work pieces, and continuously welding the work pieces by horizontally traversing the probe along a weld joint between the work pieces. Differently from existing friction stir welding, according to the present invention, the generation of plastic flow is caused only by surface friction of the probe against the work pieces since it eliminates the use of a probe pin, and the generated plastic flow permeates inside the work pieces thus causing the work pieces to be joined

### BACKGROUND OF THE INVENTION

1. Field of the Invention

The present invention relates to a friction sheet welding method using a probe for joining of metal sheets, which can achieve continuous sheet welding between the metal sheets with a good quality, without generating any welding defects.

2. Description of the Related Art

Friction welding has been known for many years and typically involves causing relative movement between a pair of work pieces to generate an appropriate amount of frictional heat on the basis of a friction principle, urging the work pieces together so as to generate a plasticised region in the work pieces around a frictional portion therebetween, and allowing the plasticised region to solidify thereby joining the work pieces together. Such friction welding has an advantage of solid phase welding, compared with general fusion welding, but further has a restriction in that frictional heat is generated only in certain region of two work pieces to be joined each other. Due to such a restriction in the generation of frictional heat, the existing conventional friction welding should satisfy a requirement in that one of the work pieces is sure to be in an axial symmetrical relation, and has a disadvantage in that it cannot be used in structures having to be continuously welded in a specific direction.

As an improvement of the above mentioned friction welding, friction stir welding has been developed in the past to join a pair of work pieces by making use of a third rigid probe and probe pin, and disclosed in published PCT applications Nos. WO 93/10935, and WO 95/26254. According to the principle of friction stir welding, as a cylindrical rod shaped probe pin, which is made of material harder than the work piece material and formed with special helical shaped protrusions enters a pair of work pieces along butt surfaces of the work pieces to be joined while causing relatively high-speed cyclic movement between the probe pin and the work pieces, frictional heat is generated by relative friction between the probe pin and work pieces thus causing the peripheral material of the work pieces around the probe pin to be thermally softened and consequently creasing a plasticised region due to the rotation of the probe pin, whereby the plasticised region is solidified to join the two work pieces together. This friction stir welding technique has an advantage of continuous-unlimited length welding, as well as of solid phase welding enabling the joining of certain materials, to which it is substantially impossible to apply the existing fusion welding techniques, such as aluminum alloy, magnesium alloy, titanium alloy, other metal based compound materials, die castings, and the like.

The conventional friction stir welding, however, has several disadvantages in that it is only applicable to a work piece having a thickness not less than 1.2 mm due to the presence of the probe pin as is presently well known, and that it causes certain welding defects since there is no longer material at the leading edge of a joint region for filling an empty space created at the trailing edge of the joint region due to the insertion of the probe pin.

In the case of metal sheets having a thickness not greater than 1.2 mm, of course, they could be joined by existing fusion welding. The existing fusion welding, however, requires highly skilled workers and inevitably requires the use of filler metal, atmospheric gas, a separate heat source, and the like, in order to achieve high welding quality. For these reasons, the existing fusion welding has a disadvantage in that the processing cost is considerably expensive. Further, the existing fusion welding generates a large amount of ultraviolet rays, fumes, dust and the like, which are harmful to the human body, thus often deteriorating worker's health and increasing safety risks, and causing difficulties in maintaining a working environment in a clean state.

### SUMMARY OF THE INVENTION

Therefore, the present invention has been made in view of the above problems, and it is an object of the present invention to provide a friction sheet welding method using a probe, which enables the joining of two work pieces, such as metal sheets, having a thickness not greater than 1.2 mm, differently from existing friction stir welding, and can achieve continuous welding without leaving any welding defects at the trailing edge of a weld joint between the work pieces.

In accordance with the present invention, the above and other objects can be accomplished by the provision of a friction sheet welding method for joining two work pieces comprising the steps of: producing forcible and intense plastic deformation at surfaces of the work pieces while generating frictional heat at the surfaces by rotating a probe at a high speed; and joining the work pieces together as the plastic deformation permeates inside material constituting the work pieces.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic perspective view illustrating a welding apparatus and process in accordance with the present invention;

FIG. 2 is a cross sectional picture illustrating a welded state of 6061 aluminum alloy sheets having a thickness of 0.9 mm;

FIG. 3 is a cross sectional picture illustrating a welded state of 1010 aluminum alloy sheets having a thickness of 1.0 mm; and

FIG. 4 is a cross sectional picture illustrating a welded state of sheets composed of different metals including a 6061 aluminum alloy sheet and a copper plate having a thickness of 0.9 mm.

### DESCRIPTION OF THE PREFERRED EMBODIMENTS

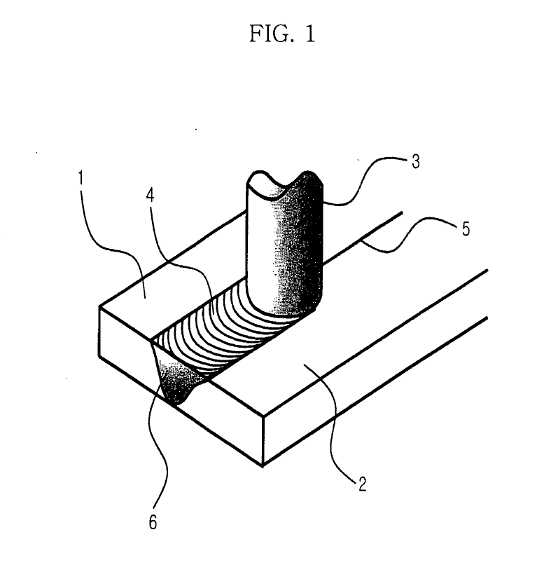

As shown in FIG. 1, in friction sheet welding between two work pieces 1 and 2, for generating an appropriate amount of frictional heat, a cylindrical rod shaped probe 3, which is coupled to a rotation driving source, is brought to the edge of a desired joint line 5 between the work pieces 1 and 2 at a constant pressure, and the probe 3 is rotated at a high speed while the prove 3 is traversed in a horizontal direction along the desired joint line 5. As a result, the work pieces 1 and 2 are joined together while producing a welding portion 4 therebetween along a butt joint region in which the desired joint line 5 is located. The welding portion 4 has a width substantially equal to a diameter of the probe 3. The rotation of the cylindrical rod shaped probe 3 produces a plasticised region 6 in the work pieces 1 and 2. The width of the plasticised region 6 is substantially equal to the diameter of the lower end of the probe 3 at the upper surfaces of the work pieces 1 and 2 just under the probe 3, but the width is gradually lessened toward the lower surfaces of the work pieces 1 and 2. A portion of the work pieces 1 and 2 contained within the plasticised region 6 is softened by the frictional heat generated from the upper surfaces of the work pieces 1 and 2 and by process heat due to plastic deformation, and consequently the work pieces 1 and 2 are joined by forcible and intense plastic flow.

Meanwhile, the depth of the plasticised region 6, which is produced by surface friction as stated above, is a factor determining the weldable thickness of the two work pieces 1 and 2. The depth of the plasticised region 6 is proportional to the diameter of the probe 3. The following equation is obtained from experimental results taken by using various diameters D of the probe relative to the weldable thickness t of the work pieces, such as metal sheets.

Equation
D≧2.0×t

The greater the diameter of the probe 3 the thicker the weldable thickness of the sheets, but this accompanies a problem of increasing the size of the welding portion 4. Further, if a rotational speed of the probe 3 is too high, it causes excessive frictional heat thus increasing temperature deviation between the surface region and interior region of material constituting the work pieces 1 and 2. As a result, the softening of the material is concentratively produced at the surface region thereof, and this makes the inward permeation of the plasticised region difficult. Meanwhile, if the work pieces and probe have high coefficients of friction, the plastic flow of the material constituting the work pieces caused at the frictional surface therebetween becomes active thus deepening the depth of the plasticised region. Therefore, in order to increase the coefficient of friction of the probe, the probe 3 is formed with a plurality of fine protrusions at the lower end surface thereof contacting with the work pieces 1 and 2. This is a great help in improving the weldability of the work pieces.

In case of the friction sheet welding according to the present invention, the plastic flow produced by the surface friction between the probe and the work pieces should be permeated inside the material constituting the work pieces, such as sheets. This means that, in the case of welding relatively thick sheets, it may often be impossible to weld them by simply adopting single pass welding. Therefore, in order to effectively join the thick sheets, double pass welding can be performed in such a fashion that secondary welding is performed at opposite surfaces of the primarily joined surfaces of the thick sheets.

The friction sheet welding of the present invention as stated above is characterized in that the generation of plastic flow is caused only by the surface friction of the probe against the work pieces since it eliminates the use of a probe pin, differently from existing friction stir welding, and the generated plastic flow permeates inside the work pieces, thereby causing the work pieces to be joined together. Therefore, the present invention advantageously achieves the welding of thin sheets, which are difficult to weld with the existing friction stir welding, and produces welded sheets having no welding defects, which are conventionally caused at the trailing edge of the weld joint region due to the use of the probe pin. In the friction sheet welding of the present invention, in order to allow the plastic flow produced at the surfaces of the work pieces to be effectively transferred inside the material constituting the work pieces, it is preferable to use a probe having a diameter twice as much or greater than the thickness of the work pieces. Further, in order to increase the coefficient of friction of the probe, it is preferable to form a plurality of fine protrusions at the lower end surface of the probe contacting with the work pieces.

Summarizing the present invention, a friction sheet welding method for joining two work pieces 1 and 2 as shown in FIG. 1, comprises the steps of:
a) firmly butting the two work pieces 1 and 2 so that their joining surfaces face each other;
b) positioning a cylindrical rod shaped probe 3, which is made of material harder than the work piece material, on a desired joint line 5 between the work pieces 1 and 2 so that it comes into contact with the work pieces 1 and 2;
c) producing forcible and intense plastic deformation at surfaces of the work pieces 1 and 2 while generating frictional heat at the surfaces by rotating the probe 3 at a high speed;
d) joining the work pieces 1 and 2 together as the plastic deformation produced at the surfaces of the work pieces 1 and 2 permeates inside material constituting the work pieces 1 and 2; and
e) continuously welding the work pieces 1 and 2 by traversing the probe 3 in a horizontal direction along the joint line 5.

### Embodiment

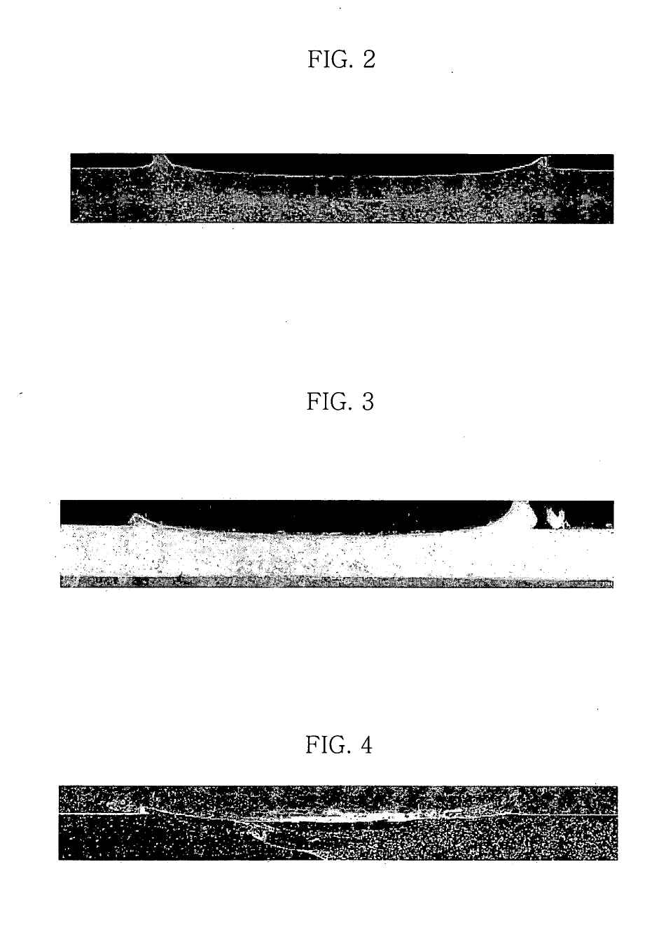

6061 aluminum alloy sheets having a thickness of 0.9 mm were welded by using a probe having a diameter of 13 mm under a rotational speed of 2000 rpm and a welding speed of 100 mm/min according to the friction sheet welding method of the present invention. FIG. 2 is a cross sectional picture illustrating a welded state of the 6061 aluminum alloy sheets. It appears that a plasticised region produced in the sheets has a maximum width at the surface region of the sheets, and is gradually narrowed inside the sheets. Under the welding conditions as stated above, it could be confirmed that the sheets having a thickness of 0.9 mm were completely joined by the friction sheet welding method proposed by the present invention.

FIG. 3 is a cross sectional picture illustrating a state wherein 1010 aluminum alloy sheets having a thickness of 1.0 mm are welded by the use of a probe having a diameter of 13 mm under a rotational speed of 1200 rpm and a welding speed of 100 mm/min. In this case, it could be also confirmed that the aluminum alloy sheets were completely joined across their vertical depth.

FIG. 4 is a cross sectional picture illustrating a state wherein a 6061 aluminum alloy sheet and a copper sheet, having a thickness of 0.9 mm, are welded by the use of a probe having a diameter of 13 mm under a rotational speed of 1800 rpm and a welding speed of 100 mm/min. It also could be confirmed from FIG. 4 that the present invention can be successfully applied even in the case of welding sheets of different materials. In conclusion, it will be understood that the friction sheet welding method using a probe proposed by the present invention can realize the complete successful joining of different materials, which is conventionally impossible using existing fusion welding.

As apparent from the above description, according to the present invention, it is possible to weld metal sheets having a thickness not greater than 1.2 mm, regardless of whether the metal sheets are made of the same or different materials, and to achieve high quality continuous welding without leaving any welding defects on the trailing edge of a weld joint region between the metal sheets. Further, according to the friction sheet welding method of the present invention, welding quality is independent of the proficiency of workers. Furthermore, since the welding method of the present invention completely eliminates the generation of rays, fumes, gas, dust and the like, which are harmful to the human body, during the welding process, it is possible to secure safety and health of workers and maintain a clean working environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A friction sheet welding method for joining two work pieces comprising the steps of:
a) firmly butting the two work pieces so that their joining surfaces face each other;
b) positioning a cylindrical rod shaped probe, which is made of material harder than the work piece material, on a weld joint line between the work pieces so as come into contact with the work pieces;
c) producing forcible and intense plastic deformation at surfaces of the work pieces while generating frictional heat at the surfaces by rotating the probe at a high speed;
d) joining the work pieces together as the plastic deformation produced at the surfaces of the work pieces permeates inside material constituting the work pieces; and
e) continuously welding the work pieces by traversing the probe in a horizontal direction along the weld joint line.

2. The method as set forth in claim 1, wherein the probe has a diameter twice as much or greater than the thickness of the work pieces.

3. The method as set forth in claim 1, wherein, in case the probe has a diameter smaller than twice the thickness of the work pieces, double pass welding is performed against both upper and lower sides of the work pieces.

4. The method as set forth in claim 1, wherein the probe has a plurality of protrusions at its lower end surface in order to increase a coefficient of friction thereof.

5. The method as set forth in claim 1, wherein the work pieces are made of the same or different materials.
